(19) United States
(12) Patent Application Publication
(10) Pub. No.: US 2023/0406229 A1
(43) Pub. Date: Dec. 21, 2023

(54) Truck Mountable Toolbox Assembly

(71) Applicant: Marco Johnson, Walker, LA (US)

(72) Inventor: Marco Johnson, Walker, LA (US)

(21) Appl. No.: 17/840,734

(22) Filed: Jun. 15, 2022

(51) Int. Cl. B60R 11/06; B25H 5/00; B25H 3/06

(52) U.S. Cl. CPC B60R 11/06; B25H 5/00; B25H 3/06; B60R 2011/004

(57) ABSTRACT

A truck mountable toolbox assembly for improving access to contents of drawers of a toolbox includes a housing, which defines an interior space and which mountable to a bed of a pickup truck behind a cab of the pickup truck. A set of swinging drawers is positioned in the interior space, with each swinging drawer being aligned with an associated aperture of a plurality of apertures positioned in the front of the housing. Each swinging drawer is pivotable relative a respective opposed end of the housing and thus is selectively extensible from the front of the housing. The contents of the swinging drawer are accessible from an associated opposed side of the bed.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to toolbox assemblies and more particularly pertains to a new toolbox assembly for improving access to contents of drawers of a toolbox. The present invention discloses a toolbox assembly comprising the housing that is mountable to a bed of a pickup truck. A set of swinging drawers allows access to tools from an associated opposed side of the bed without requiring a user to climb onto the bed.

### (2) Description of Related Art Including Information Disclosed Under 37 CFR 1.97 and 1.98

The prior art relates to toolbox assemblies. Prior art toolbox assemblies may comprise pickup trucks having doors in their sidewalls for accessing tool compartments or allowing for extension of drawers, upwardly extendable toolboxes, siderail mountable toolboxes with doors in their sides, which may have extensible drawers, and toolboxes that are slidably attached to the siderails. What is lacking in the prior art is a toolbox assembly comprising the housing that is mountable to bed of a pickup truck behind its cab, from which a set of swinging drawers can be pivoted to allow access to tools, equipment, and supplies from an associated opposed side of the bed.

### (h) BRIEF SUMMARY OF THE INVENTION

An embodiment of the disclosure meets the needs presented above by generally comprising a housing, which defines an interior space and which is configured to be mount to a bed of a pickup truck behind a cab of the pickup truck. A set of swinging drawers is positioned in the interior space, with each swinging drawer being aligned with an associated aperture of a plurality of apertures positioned in the front of the housing. Each swinging drawer is pivotable relative a respective opposed end of the housing and thus is selectively extensible from the front of the housing. The contents of the swinging drawer are accessible from an associated opposed side of the bed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a truck mountable toolbox assembly according to an embodiment of the disclosure.

FIG. 2 is a front view of an embodiment of the disclosure.

FIG. 3 is an isometric perspective view of an embodiment of the disclosure.

FIG. 4 is a rear view of an embodiment of the disclosure.

FIG. 5 is an in-use view of an embodiment of the disclosure.

### (j) DETAILED DESCRIPTION OF THE INVENTION

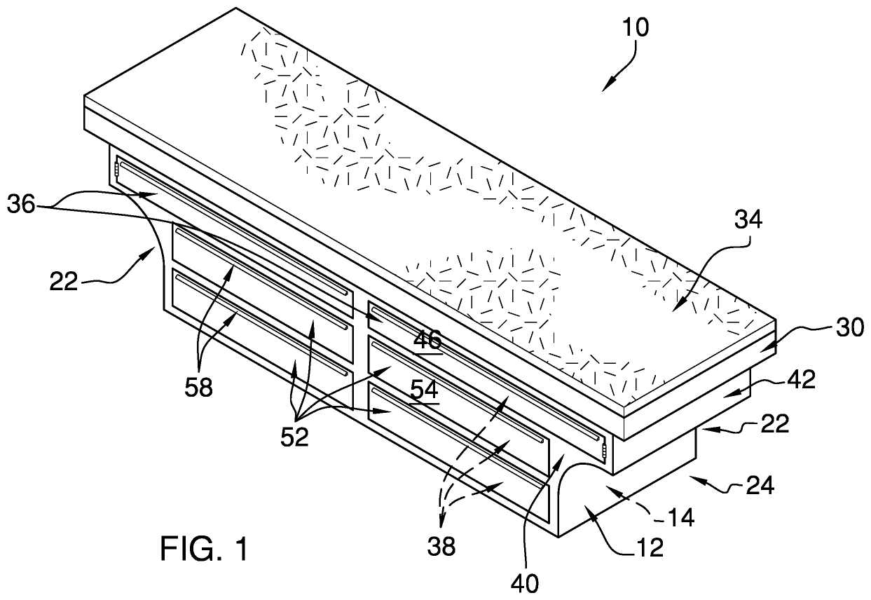

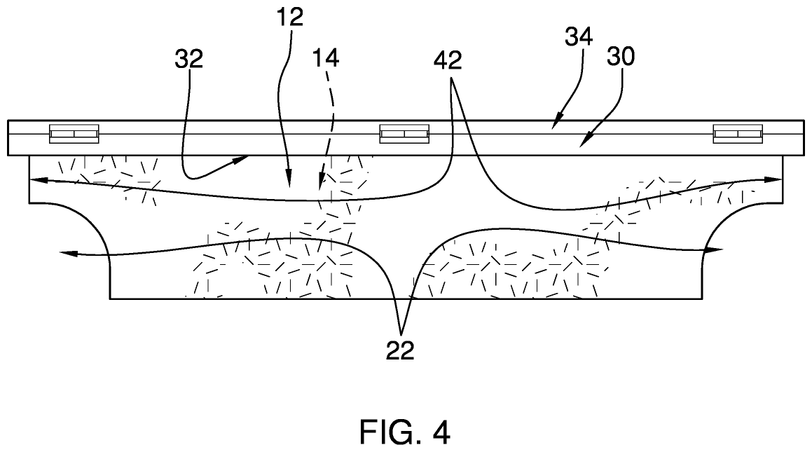

With reference now to the drawings, and in particular to FIGS. 1 through 5 thereof, a new toolbox assembly embodying the principles and concepts of an embodiment of the disclosure and generally designated by the reference numeral 10 will be described.

As best illustrated in FIGS. 1 through 5, the truck mountable toolbox assembly 10 generally comprises a housing 12, which defines an interior space 14 and which is configured to be mounted to a bed 16 of a pickup truck 18 behind a cab 20 of the pickup truck 18. Each of a pair of recesses 22 extends arcuately into the housing 12 from a respective bottom side edge 24 of the housing 12. The recess 22 is complementary to a curvature 26 of an associated opposed side 28 of the bed 16 so that the housing 12 is insertable into the bed 16. A tray 30 is attached to a top 32 of the housing 12 and can be used to stow tools, equipment, and the like. A lid 34 is hingedly attached to the tray 30 and is positioned to selectively close the tray 30.

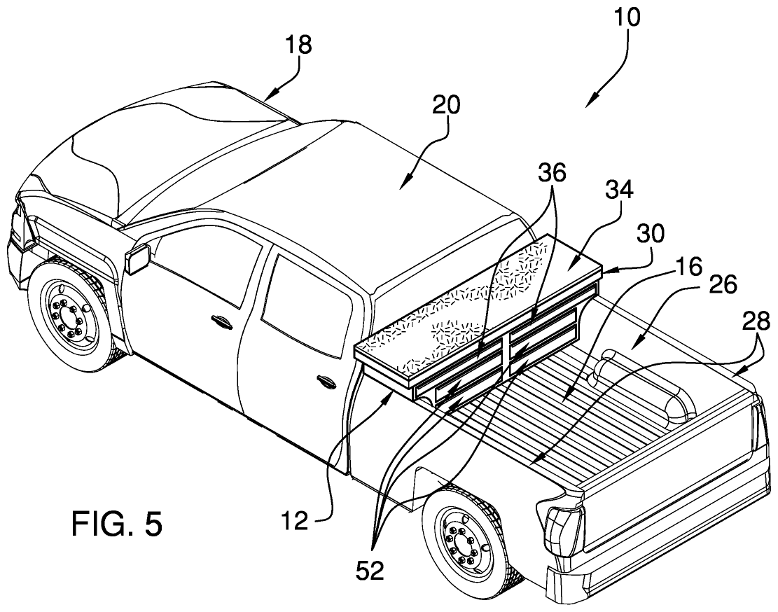

A set of swinging drawers 36 is positioned in the interior space 14, with each swinging drawer 36 being aligned with an associated aperture 38 of a plurality of apertures 38 that is positioned in a front 40 of the housing 12. Each swinging drawer 36 is pivotable relative a respective opposed end 42 of the housing 12 and thus is selectively extensible from the front 40 of the housing 12. The contents of the swinging drawer 36 are accessible from an associated opposed side 28 of the bed 16, as shown in FIG. 5.

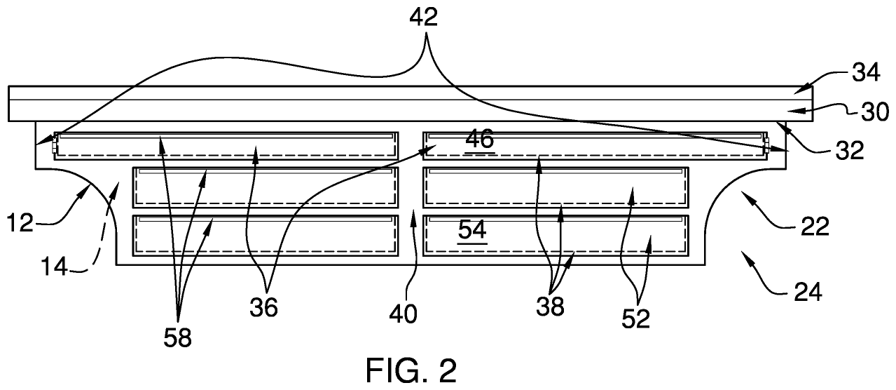

The swinging drawer 36 is hingedly engaged by a forward corner 44 to the housing 12 proximate to the respective opposed end 42 of the housing 12. The swinging drawer 36 is selectively positionable in a stowed configuration and an extended configuration, as shown in FIG. 2, wherein the swinging drawer 36 to the left is in the extended configuration and the swinging drawer 36 to the right is in the stowed configuration. In the stowed configuration, a forward facet 46 of the swinging drawer 36 substantially closes an associated aperture 38. In the extended configuration, the forward facet 46 is substantially parallel to the associated opposed side 28 of the bed 16.

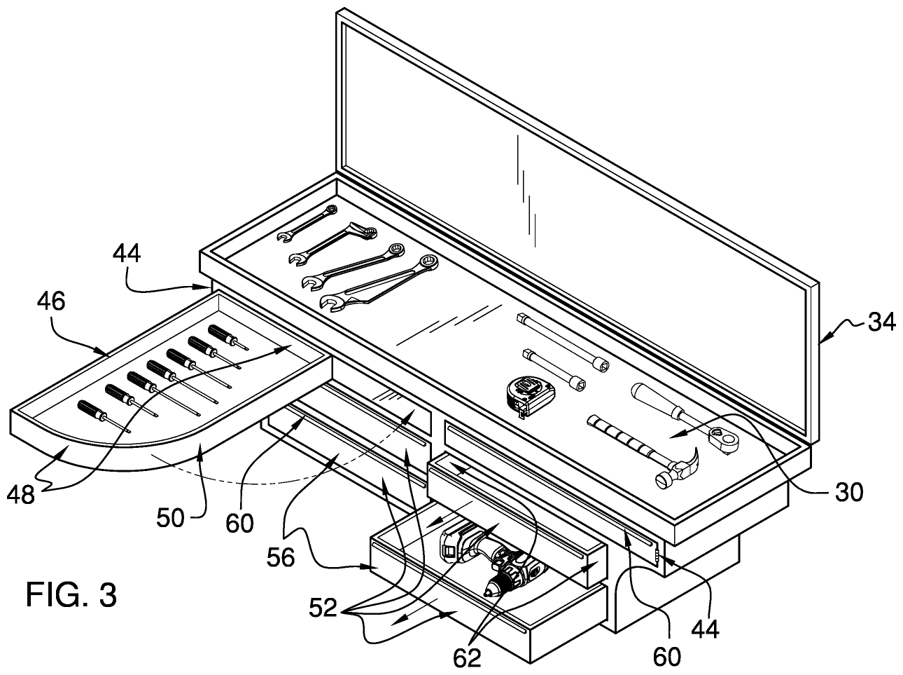

As shown in FIG. 3, a respective opposed side facet 48 of the swinging drawer 36 extends arcuately to a rear facet 50 of the swinging drawer 36. The swinging drawer 36 being shaped thus allows the swinging drawer 36 to be pivotable between the stowed configuration and the extended configuration. The set of swinging drawers 36 may comprise two swinging drawers 36, which are positioned proximate to the top 32 of the housing 12. The swinging drawers 36 pivot opposingly when they are being positioned in their respective extended configurations. The present invention also anticipates additional swinging drawers 36 being positioned below the two swinging drawers 36 shown in FIGS. 2 and 3. The present invention also anticipates each swinging drawer 36 being operationally engaged to a respective actuator of a set of actuators (not shown), which could be selectively actuated to open and close the swinging drawers 36.

The truck mountable toolbox assembly 10 also may comprise a set of sliding drawers 52. Each sliding drawer 52 is selectively extensible from the front 40 of the housing 12. A front face 54 of the sliding drawer 52 substantially closes an associated aperture 38 when the sliding drawer 52 is closed. As shown in FIG. 2, the set of sliding drawers 52 comprises four sliding drawers 52 that are positioned in two rows 56 of two sliding drawers 52 below the set of swinging drawers 36. The present invention also anticipates alternative configurations for the set of sliding drawers 52, such as, but not limited to, sliding drawers 52 that extend substantially between the opposed ends 42 of the housing 12, two sliding drawers 52 that are larger in size than is depicted in FIG. 2, or more than four sliding drawers 52 that are smaller in size than is depicted in FIG. 2.

Each of a plurality of handles 58 is attached to a respective one of the set of swinging drawers 36 and the set of sliding drawers 52. Each swinging drawer 36 and each sliding drawer 52 thus is affixed with a handle 58, as shown in FIG. 1. The handle 58 is configured to be grasped in a hand or to engage fingers of a user to open the respective one of the set of swinging drawers 36 and the set of sliding drawers 52. The handle 58 may comprise a curved plate 60, which extends substantially between the opposed side facets 48 of the swinging drawer 36 or substantially between opposed side panels 62 of the sliding drawer 52 so that the curved plate 60 is configured to engage the fingers of the user. The handle 58 also may comprise a pull handle, a knob, or the like.

The present invention also anticipates a plurality of locks (not shown) with each lock being engaged to a respective one of the lid 34, the set of swinging drawers 36, and the set of sliding drawers 52. The locks would be selectively couplable to the housing 12 to secure the lid, the swinging drawers 36, and the sliding drawers 52 in a closed, inaccessible configuration.

In use, the housing 12 is mounted to the bed 16 of a pickup truck 18 behind its cab 20, as per prior art toolbox assemblies. Tools, equipment, and supplies are stowed in the set of swinging drawers 36. Each swinging drawer 36 can be pivoted relative a respective opposed end 42 of the housing 12 to allow access to the tools, equipment, and supplies from an associated opposed side 28 of the bed 16. The present invention provides access to the contents of the swinging drawers 36 without requiring a user to climb onto the bed 16 of the pickup truck 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A truck mountable toolbox assembly comprising:
a housing defining an interior space, the housing being configured for mounting to a bed of a pickup truck behind a cab of the pickup truck; and
a set of swinging drawers positioned in the interior space, each swinging drawer being aligned with an associated aperture of a plurality of apertures positioned in the front of the housing, the swinging drawer being pivotable relative a respective opposed end of the housing, such that the swinging drawer is selectively extensible from a front of the housing pivoting away from a center of the housing wherein the swinging drawer is configured for positioning adjacent to an associated opposed side of the bed wherein contents of the swinging drawer are accessible from the associated opposed side of the bed.

2. The truck mountable toolbox assembly of claim 1, further including:
a tray attached to a top of the housing; and
a lid hingedly attached to the tray, such that the lid is positioned for selectively closing the tray.

3. The truck mountable toolbox assembly of claim 1, wherein:
the swinging drawer is hingedly engaged by a forward corner to the housing proximate to the respective opposed end of the housing, such that the swinging drawer is selectively positionable in a stowed configuration, wherein a forward facet of the swinging drawer substantially closes an associated aperture, and an extended configuration, wherein the forward facet is substantially parallel to the associated opposed side of the bed; and
a respective opposed side facet of the swinging drawer extending arcuately to a rear facet of the swinging drawer, such that the swinging drawer is pivotable between the stowed configuration and the extended configuration.

4. The truck mountable toolbox assembly of claim 1, wherein the set of swinging drawers comprises two swinging drawers positioned proximate to the top of the housing, such that the swinging drawers pivot opposingly when being positioned in their respective extended configurations.

5. The truck mountable toolbox assembly of claim 4, further including a set of sliding drawers, each sliding drawer being selectively extensible from a front of the housing, a front face of the sliding drawer substantially closing an associated aperture.

6. The truck mountable toolbox assembly of claim 5, wherein the set of sliding drawers comprises four sliding drawers positioned in two rows of two sliding drawers below the set of swinging drawers.

7. The truck mountable toolbox assembly of claim 5, further including a plurality of handles, each handle being attached to a respective one of the set of swinging drawers and the set of sliding drawers, such that each swinging drawer and each sliding drawer is affixed with a handle, wherein the handle is configured for grasping in a hand or for engaging fingers of a user for opening the respective one of the set of swinging drawers and the set of sliding drawers.

8. The truck mountable toolbox assembly of claim 7, wherein the handle comprises a curved plate extending substantially between the opposed side facets of the swinging drawer or substantially between opposed side panels of the sliding drawer, such that the curved plate is configured for engaging the fingers of the user.

9. The truck mountable toolbox assembly of claim 1, further including a pair of recesses, each recess extending arcuately into the housing from a respective bottom side edge of the housing, the recess being complementary to a curvature of an associated opposed side of the bed, such that the housing is insertable into the bed of the pickup truck.

10. A truck mountable toolbox system comprising:
a pickup truck comprising a cab and a bed;
a housing mounting to the bed behind the cab, the housing defining an interior space; and
a set of swinging drawers positioned in the interior space, each swinging drawer being aligned with an associated aperture of a plurality of apertures positioned in the front of the housing, the swinging drawer being pivotable relative a respective opposed end of the housing, such that the swinging drawer is selectively extensible from a front of the housing pivoting away from a center of the housing wherein the swinging drawer is configured for positioning adjacent to an associated opposed side of the bed wherein contents of the swinging drawer are accessible from the associated opposed side of the bed.

11. The truck mountable toolbox system of claim 10, further including:
a tray attached to a top of the housing; and
a lid hingedly attached to the tray, such that the lid is positioned for selectively closing the tray.

12. The truck mountable toolbox system of claim 10, wherein:
the swinging drawer is hingedly engaged by a forward corner to the housing proximate to the respective opposed end of the housing, such that the swinging drawer is selectively positionable in a stowed configuration, wherein a forward facet of the swinging drawer substantially closes an associated aperture, and an extended configuration, wherein the forward facet is substantially parallel to the associated opposed side of the bed; and
a respective opposed side facet of the swinging drawer extending arcuately to a rear facet of the swinging drawer, such that the swinging drawer is pivotable between the stowed configuration and the extended configuration.

13. The truck mountable toolbox system of claim 10, wherein the set of swinging drawers comprises two swinging drawers positioned proximate to the top of the housing, such that the swinging drawers pivot opposingly when being positioned in their respective extended configurations.

14. The truck mountable toolbox system of claim 13, further including a set of sliding drawers, each sliding drawer being selectively extensible from a front of the housing, a front face of the sliding drawer substantially closing an associated aperture.

15. The truck mountable toolbox system of claim 14, wherein the set of sliding drawers comprises four sliding drawers positioned in two rows of two sliding drawers below the set of swinging drawers.

16. The truck mountable toolbox system of claim 14, further including a plurality of handles, each handle being attached to a respective one of the set of swinging drawers and the set of sliding drawers, such that each swinging drawer and each sliding drawer is affixed with a handle, wherein the handle is configured for grasping in a hand or for engaging fingers of a user for opening the respective one of the set of swinging drawers and the set of sliding drawers.

17. The truck mountable toolbox system of claim 16, wherein the handle comprises a curved plate extending substantially between the opposed side facets of the swinging drawer or substantially between opposed side panels of the sliding drawer, such that the curved plate is configured for engaging the fingers of the user.

18. The truck mountable toolbox system of claim 10, further including a pair of recesses, each recess extending arcuately into the housing from a respective bottom side edge of the housing, the recess being complementary to a curvature of an associated opposed side of the bed.

19. A truck mountable toolbox assembly comprising:
a housing defining an interior space, the housing being configured for mounting to a bed of a pickup truck behind a cab of the pickup truck;
a tray attached to a top of the housing;
a lid hingedly attached to the tray, such that the lid is positioned for selectively closing the tray;
a set of swinging drawers positioned in the interior space, each swinging drawer being aligned with an associated aperture of a plurality of apertures positioned in the front of the housing, the swinging drawer being pivotable relative a respective opposed end of the housing, such the swinging drawer is selectively extensible from a front of the housing pivoting away from a center of the housing wherein the swinging drawer is configured for positioning adjacent to an associated opposed side of the bed wherein contents of the swinging drawer are accessible from the associated opposed side of the bed, the swinging drawer being hingedly engaged by a forward corner to the housing proximate to the respective opposed end of the housing, such that the swinging drawer is selectively positionable in a stowed configuration, wherein a forward facet of the swinging drawer substantially closes an associated aperture, and an extended configuration, wherein the forward facet is substantially parallel to the associated opposed side of the bed, a respective opposed side facet of the swinging drawer extending arcuately to a rear facet of the swinging drawer, such that the swinging drawer is pivotable between the stowed configuration and the extended configuration, the set of swinging drawers comprising two swinging drawers positioned proximate to the top of the housing, such that the swinging drawers pivot opposingly when being positioned in their respective extended configurations;
a set of sliding drawers, each sliding drawer being selectively extensible from a front of the housing, a front face of the sliding drawer substantially closing an associated aperture, the set of sliding drawers comprising four sliding drawers positioned in two rows of two sliding drawers below the set of swinging drawers;
a plurality of handles, each handle being attached to a respective one of the set of swinging drawers and the set of sliding drawers, such that each swinging drawer and each sliding drawer is affixed with a handle, wherein the handle is configured for grasping in a hand or for engaging fingers of a user for opening the respective one of the set of swinging drawers and the set of sliding drawers, the handle comprising a curved plate extending substantially between the opposed side facets of the swinging drawer or substantially between opposed side panels of the sliding drawer, such that the curved plate is configured for engaging the fingers of the user, and
a pair of recesses, each recess extending arcuately into the housing from a respective bottom side edge of the housing, the recess being complementary to a curvature of an associated opposed side of the bed, such that the housing is insertable into the bed of the pickup truck.
